(19) United States
(12) Patent Application Publication
(10) Pub. No.: US 2005/0119935 A1
(43) Pub. Date: Jun. 2, 2005

(54) System and method for managing the display of unsolicited instant web advertisements

(75) Inventors: Gregory J. Boss, Salt Lake City, UT (US); Kevin C. McConnell, Austin, TX (US)

Correspondence Address: Samuel A. Kassatly, 6819 Trinidad Drive, San Jose, CA, 95120, US

(73) Assignee: International Business Machines Corporation, Armonk, NY (US)

(21) Appl. No.: 10/726,186

(22) Filed: Dec. 1, 2003

(51) Int. Cl. G06F 17/60

(52) U.S. Cl. 705/14

(57) ABSTRACT

An unsolicited instant ad manager manages the display of unsolicited instant web advertisements such as pop-up and pop-under ads. Unsolicited instant ads are moved to a secondary browser window, container, or file and aggregated. Transferred ads can be viewed by accessing a master instant ad window. The transferred ads maintain their original appearance and functionality. Otherwise, the ads may be presented in digest form or as a log. The user may view the advertisements by scrolling through a window displaying the ads. Additional information may be appended to the ad display. The user may be notified when an ad is trapped and moved. The unsolicited instant ad manager may activate hyperlinks in the ads to mimic interaction by the user. Desired actions performed by a web page utilizing the functionality of a pop-up window are allowed; advertisements are disallowed. Advertisements may be further filtered by criteria such as keyword.

### FIELD OF THE INVENTION

The present invention generally relates to instant advertisements encountered when accessing pages on the World Wide Web. More specifically, the present invention pertains to a method for managing and filtering unsolicited instant advertisements by moving them to an alternate master ad window, file, or container for later viewing and deleting undesired unsolicited instant advertisements.

### BACKGROUND OF THE INVENTION

The World Wide Web (WWW) is comprised of an expansive network of interconnected computers upon which businesses, governments, groups, and individuals throughout the world maintain inter-linked computer files known as web pages. Users navigate these web pages by means of computer software programs commonly known as Internet browsers. The authors of web pages provide information known as metadata within the body of the hypertext markup language (HTML) document that defines the web pages.

By specifying a uniform resource locator (URL), a user can obtain any web page accessible through the Internet. That web page may have embedded in it links to other web pages. These embedded links may appear to the user despite the user's wishes to the contrary. In particular, advertisements may appear to users of the WWW in various forms such as, for example, banner ads (or advertisements) or instant ads. Banner ads appear across the top or bottom of the web page. Such ads may comprise scrolled information containing images that change with time.

Instant ads are ads such as pop-up or pop-under advertisements. Pop-up advertisements are those generally small windows that come to the foreground of a web page and take the focus away from the user's current window. Pop-under advertisements are created beneath the current set of windows in the web page. Pop-under ads have the effect of being invisible until all other windows are minimized or closed. Some pop-up and pop-under advertisements are delivered on a timer set by a currently active web site.

In general, unsolicited instant ads annoy Internet users. Pop-up ads clutter the browser screen, requiring users to clear the pop-up windows one at a time to view the content of the web site. Pop-under ads collect under the currently active browser screen. Methods for mitigating the appearance of unsolicited instant ads have proliferated. The tremendous numbers of unsolicited instant ad “killers” currently available attests to the antipathy users have for these ads.

Many instant ad managers close unsolicited instant ads destructively by either preventing the instant ad from being created or by removing the instant ad after it has been created. These methods allow the user to know that the instant ad was stopped. In some cases, these methods allow the user to answer a prompt for each advertisement or each site as to whether or not a pop-up or pop-under advertisement is accepted or destroyed.

However, current technology for controlling instant ads on user's browsers prevents the hosting site from collecting revenue. Many sites choose to use advertisements as a primary means to fund the hosting and transfer costs. Many web hosts provide sites for free to users in exchange for the ability to post advertisements on that user's web site. Other users browsing the Internet are able to view the web site because the web site is essentially financed through advertisements such as unsolicited instant ads.

The web site host tracks the response to unsolicited instant ads on particular web sites. When a user clicks on an unsolicited instant ad, a unique set of information is sent to the web host's server indicating that an advertisement posted through a specific web site garnered a response. The web site responsible for that ad then receives a credit, for example. These credits may translate to money or to other benefits. Conversely, if no visitors to a web site respond to the advertisements or the unsolicited instant ads are “killed” (i.e., closed) by instant ad managers, no revenue is generated by the web site for the web site host. The web site host may then choose to close the web site because it generates no revenue for the web site host.

Some services available on present web sites utilize the same technology as the instant advertisement. Consequently, the ability to receive instant advertisements is required for a user to interact with those sites. For example, information from the user such as user ID and password in forms may be requested within a pop-up window.

An instant ad may require information in the same pop-up window as the advertisement. In addition, a host web site may comprise logic that can detect whether the advertisement has been displayed. Some functionality of the web site may be denied if instant advertisements are disallowed, presenting a disadvantage to the end user.

What is therefore needed is a system, a computer program product, and an associated method for allowing users to avoid the nuisance of dealing with multiple unsolicited instant ads during the Internet browsing experience while still allowing advertisers to present the advertisement to the user. The need for such a solution has heretofore remained unsatisfied.

### SUMMARY OF THE INVENTION

The present invention satisfies this need, and presents a system, a computer program product, and an associated method (collectively referred to herein as “the system” or “the present system”) for “silently” moving unsolicited instant advertisements such as pop-up ads and pop-under ads to another location rather than destroying them or preventing them from displaying. The present system moves these instant ads silently, without knowledge by the user of the appearance or resultant management of the unsolicited instant ad.

The present system moves the instant ads to a single container or window and aggregates them together. Consequently, all unsolicited instant ads encountered by the user while browsing the Internet can be viewed by accessing a master instant ad window at the convenience of the user.

All unsolicited instant ads are programmatically moved to a single browser window and appended so that the unsolicited instant ads can be reviewed and acted upon at a later time. The present system monitors the creation of all new unsolicited instant ads. When such event is found, the present system captures the content of that unsolicited ad and moves that content to a master instant ad window. Content of the unsolicited ad may comprise graphics, text, forms, etc.

In an embodiment, the container may be a database that characterizes the unsolicited instant ads from the metadata attached to the content of the unsolicited instant. This embodiment allows the user to easily sort and group unsolicited instant ads in a variety of ways. This database allows the user to select and view all the unsolicited instant advertisements that are, for example, created from a specific retail establishment or collection of retailers or businesses. The user may also select and view unsolicited instant advertisements based on products, content, category (health, automotive, insurance, electronics, etc.), etc.

In a more complex implementation, the container may be a database, to allow the user to readily sort and group adds in various ways. Without a database the adds would typically just show up in the order they were created. With a database, the user could choose to see all the adds created from a particular store, collection of stores or businesses, types of add based on content (e.g., health related, automotive, insurance, electronic, etc.).

The unsolicited instant ads may be transferred to an alternate location comprising a window, a file, or a container. The unsolicited instant ads may appear with graphics intact, exactly as they appear as a pop-up or pop-under ad. In an embodiment, the unsolicited ads may be presented in digest form without graphics or as a log. The user may view the advertisements by scrolling through a window or list displaying the transferred instant advertisements. Information about the company presenting the unsolicited instant ad may be appended to the display of the unsolicited instant ad in the alternate location. This information about the company may be determined, for example, from databases, reports, privacy policies, cookie use, etc.

The master instant ad window typically remains open while the user is browsing the Internet. Unsolicited instant ads encountered during an Internet browsing session are moved to the master instant ad window. Within the master instant ad window, the present system maintains the properties of the instant ad. At any time, the user can maximize or restore the master instant ad window, view the contents, and act upon those contents. In an embodiment, the present system may notify the user when an instant ad is trapped and moved. This notification may be, for example, a flashing icon in the task tray or start bar, an audible sound, etc. In a further embodiment, the notification may be selected as a preference by the user or configured on a site-by-site basis.

In another embodiment, the present system may be configured to further reward the web site issuing the unsolicited instant advertisement. Often a web site host receives increased revenue if a user interacts with the unsolicited instant ad. The present system scans the content of the unsolicited instant advertisement for hyperlinks. If hyperlinks are found, the present system automatically activates one or more of those hyperlinks to catch and handle the unsolicited instant advertisement by the same mechanism in the current art. In an embodiment, the present system applies intelligent rules to ensure that only benign links are traversed. Consequently, the present system brings increased profit to the host web site. In an embodiment, the user may specify which web sites and which unsolicited instant advertisements are to be rewarded in this manner, reinforcing acceptable unsolicited instant advertisements presented by the web site and ignoring unacceptable unsolicited instant advertisements.

In a further embodiment, the present system creates a log that may be stored or e-mailed to a user. This log is maintained according to preferences set by the user. The user is not required to interact with a master instant ad window and may review at a later time unsolicited instant ads that have been captured. Many advertisements are targeted specifically to the user according to habits, sites visited, preferences, etc. This feature of the present system captures those instant ads for later review by the user.

The present system has the advantage of allowing web sites to collect advertising revenue from instant ads while protecting the user from bombardment by instant advertisements while browsing the Internet. The web site host has the advantage of collecting the revenue generated by the instant advertisement. The end user may conveniently access the information in a single instant ad window available at anytime. Consequently, the end user may view the ad at the user's convenience rather than while browsing the Internet.

In an additional feature of the present system, unsolicited instant ads transferred to the instant ad window may be filtered by some criteria such as key word or subject. The user may disallow the appearance of advertisements for offensive or undesired products while allowing instant ads for items of interest to appear in the instant ad window. This filter may be applied to the unsolicited ads as they are encountered by the present system. Consequently, all unsolicited instant ads appearing on the user's browser have the appearance of interaction with the user while the user views only those unsolicited ads that match the user's criteria.

For example, a user may visit fifty sites throughout a day, each of which placed one pop-up advertisement. These pop-up advertisements are trapped, filtered, and moved to the master instant ad window. At the end of the day, the user wishes to review the captured pop-up ads for any items or offers of interest. The user has preset the instant ad filter to eliminate advertisements for weight loss and mortgage refinancing. Now the user has only twenty advertisements remaining for review.

In a further embodiment, the present system may be configured to allow unsolicited instant ads for only those subjects specified by the user. For example, the user may be interested in model airplanes, digital cameras, and DVD movies. Consequently, the present system eliminates all unsolicited instant ads from the master instant ad window that do not meet the specified criteria.

In another embodiment, the user may update filters while reviewing the captured unsolicited instant advertisements. In the midst of the reviewing process, the user may find an unsolicted instant advertisement that has been captured but is no longer desired. The user may then instruct the present system to no longer capture this unsolicited instant advertisement. The user may, for example, click a “block” button or perform any other action that informs the present system that this unsolicited instant advertisement is to be blocked. In addition, the user may also specify that an unsolicited instant advertisement of a particular topic, content, or retailer be allowed. The user may then instruct the present system to allow these unsolicited instant advertisements to pop-up or pop-under in a normal fashion.

### BRIEF DESCRIPTION OF THE DRAWINGS

The various features of the present invention and the manner of attaining them will be described in greater detail with reference to the following description, claims, and drawings, wherein reference numerals are reused, where appropriate, to indicate a correspondence between the referenced items, and wherein:

FIG. 1 is a schematic illustration of an exemplary operating environment in which an unsolicited instant ad management system of the present invention can be used;

FIG. 2 is comprised of FIGS. 2A and 2B and represents a process flow chart illustrating a method of operation of the unsolicited instant ad management system of FIG. 1; and

FIG. 3 is block diagram illustrating an exemplary screen shot portraying the operation of the unsolicited instant ad management system of FIGS. 1 and 2.

### DETAILED DESCRIPTION OF PREFERRED EMBODIMENTS

The following definitions and explanations provide background information pertaining to the technical field of the present invention, and are intended to facilitate the understanding of the present invention without limiting its scope:

Internet: A collection of interconnected public and private computer networks that are linked together with routers by a set of standard protocols to form a global, distributed network.

URL (Uniform Resource Locator): A unique address that fully specifies the location of a content object on the Internet. The general format of a URL is protocol://server-address/path/filename.

Web document or page: A collection of data available on the World Wide Web and identified by a URL. In the simplest, most common case, a web page is a file written in HTML and stored on a web server. It is possible for the server to generate pages dynamically in response to a request from the user. A web page can be in any format that the browser or a helper application can display. The format is transmitted as part of the headers of the response as a MIME type, e.g. “text/html”, “image/gif”. An HTML web page may typically refer to other web pages and Internet resources by including hypertext links.

Web site: A database or other collection of inter-linked hypertext documents (“web documents” or “web pages”) and associated data entities, that is accessible via a computer network, and that forms part of a larger, distributed informational system such as the WWW. In general, a web site corresponds to a particular Internet domain name, and comprises the content of a particular organization. Other types of web sites may comprise, for example, a hypertext database of a corporate “intranet” (i.e., an internal network that uses standard Internet protocols), or a site of a hypertext system that uses document retrieval protocols other than those of the WWW.

World Wide Web (WWW, also Web): An Internet client-server hypertext distributed information retrieval system.

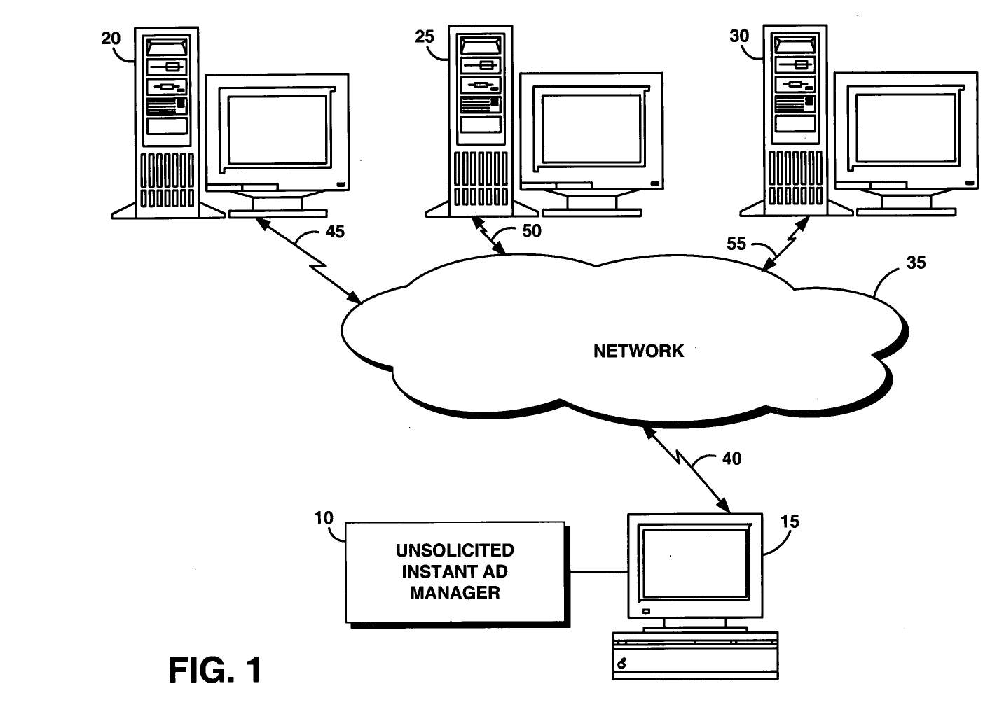

FIG. 1 portrays an exemplary overall environment in which a system and associated method for managing the display of unsolicited instant web advertisements (ads) according to the present invention may be used. System 10 comprises a software programming code or a computer program product that is typically embedded within, or installed on a computer 15. Alternatively, system 10 can be saved on a suitable storage medium such as a diskette, a CD, a hard drive, or like devices.

Web site hosts represented by servers 20, 25, 30 host web sites that may be accessed by a user represented by computer 15. Computer 15 can access servers 20, 25, 30 through a network 35. Computer 15 comprises software that allows the user to interface securely with servers 20, 25, 30. The computer 15 is connected to network 35 such as the Internet via a communications link 40 such as a telephone, cable, or satellite link. Servers 20, 25, 30 can be connected to network 35 via communications links 45, 50, 55, respectively. While system 10 is described in terms of network 35, computer 15 may access servers 20, 25, 30 locally rather than remotely. Computer 15 may access servers 20, 25, 30 either manually or automatically through the use of an application.

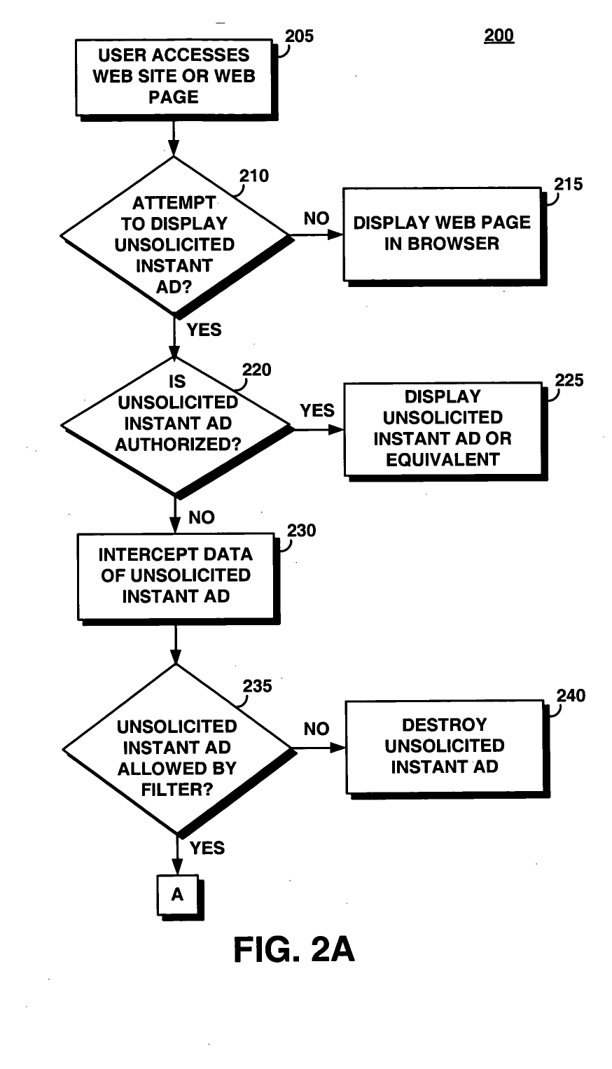

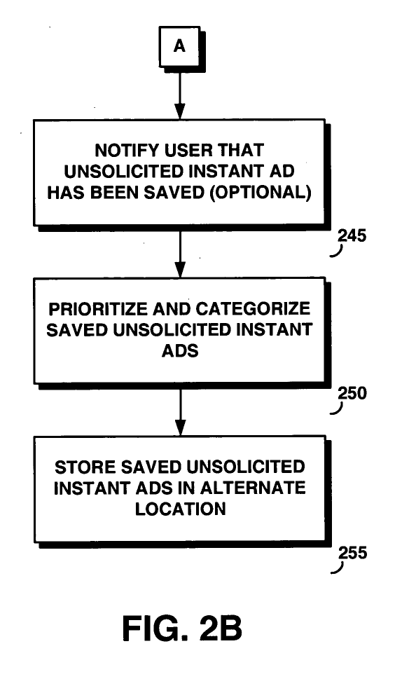

A method 200 of operation of system 10 is illustrated by the process flow chart of FIG. 2 (FIGS. 2A, 2B). A user accesses a web site or web page at step 205 through a web browser. System 10 monitors the Internet network traffic at computer 15 for attempts to display unsolicited instant ads at step 210. Unsolicited instant ads are automatically generated by the web site being visited by the user and are easily distinguished by system 10 from actions taken by the user in browsing the WWW. Unsolicited instant ads may comprise text, graphics, forms, etc. If the creation of a new window is not the result of an attempt to display an unsolicited instant ad, system 10 displays the web page in the primary browser of computer 15 (step 215).

If the creation of a new window is an attempt to display an unsolicited instant ad at decision step 210, system 10 determines whether the unsolicited instant ad is authorized by the user at decision step 220. A user may wish to allow some actions by web pages that use the same mechanism as unsolicited instant ads, for example, login screens requesting user ID and password, help menus, etc. A user may also allow immediate appearance of unsolicited instant ads that match specified keywords or subjects. If the unsolicited instant ad is authorized by the user at decision step 220, the unsolicited instant ad is displayed at step 225.

If system 10 determines at decision step 220 that the unsolicited instant ad is not authorized for immediate display, system 10 intercepts the data in the unsolicited instant ad (step 230). The data in the unsolicited instant ad is trapped “silently”, without the knowledge by the user of the event.

At decision step 235, a filter of system 10 compares the data in the unsolicited instant ad with user preferences for receiving unsolicited ads. The filter may disallow unsolicited instant ads based on user criteria such as, for example, not allowing any unsolicited ads that comprise pornographic items, mortgage refinancing, or specific pharmaceuticals. Conversely, the filter may be configured to allow unsolicited instant ads that meet user criteria such as, for example, specific hobby interests, computer hardware in which the user is interested, DVD movies, etc. If the unsolicited instant ad does not meet the criteria imposed by the user, the unsolicited instant ad is destroyed at step 240.

System 10 may optionally notify the user at step 245 when an unsolicited instant ad has been saved. This notification may be, for example, a flashing icon in a task tray or start bar, an audible sound, etc. In an embodiment, the notification may be selected as a preference by the user or configured on a site-by-site basis.

At step 250, system 10 prioritizes and categorizes the saved unsolicited instant ads. System 10 then stores the saved unsolicited instant ads in an alternate location at step 255. The alternate location may comprise a browser window, a file, or a container. The unsolicited instant ads may appear with graphics intact, exactly as they appear as a pop-up or pop-under ad, for example. In an embodiment, the unsolicited ads may be presented in digest form without graphics or as a log. The user may view the advertisements by scrolling through a browser window or list displaying the transferred instant advertisements.

If the alternate location is a browser window, this master instant ad window typically remains open while the user is browsing the Internet. Instant ads saved during an Internet browsing session are moved to the master instant ad window. Within the master instant ad window, system 10 maintains all the properties of the instant ad. At any time, the user can maximize or restore the master instant ad window, view the contents, and act upon those contents.

In an embodiment, system 10 scans the content of the unsolicited instant ads that have been saved at decision step 235. Any hyperlinks found on the saved unsolicited instant ads are then activated using intelligent rules to insure that only benign links are traversed. Often a web site host receives increased revenue if a user interacts with the unsolicited instant ad. Consequently, system 10 can bring increased profit to the host web site for displaying unsolicited instant ads that meet the user's criteria.

In a further embodiment, system 10 filters the saved unsolicited instant ads and activates the hyperlinks found only on those unsolicited instant ads that meet the filter criteria. For example, a website useful to a user may be supported by advertisers or unsolicited instant advertisements that the user finds offensive. The user may specify that system 10 activate links on the unsolicited instant advertisements that meet the user's criteria while ignoring the undesirable unsolicited instant advertisements. In this manner, the website receives revenue for the acceptable unsolicited instant advertisement and not the unacceptable unsolicited instant advertisement. In this manner, the website receives valuable feedback on the effectiveness of their unsolicited instant advertisements. In addition, this indirect feedback from users may influence the website to drop the offensive advertisements and pursue advertisements that are not offensive.

In a further embodiment, system 10 creates a log that may be stored as a browser window or e-mailed to a user. This log is maintained according to preferences set by the user. The user is not required to interact with a master instant ad window and may review at a later time unsolicited instant ads that have been captured.

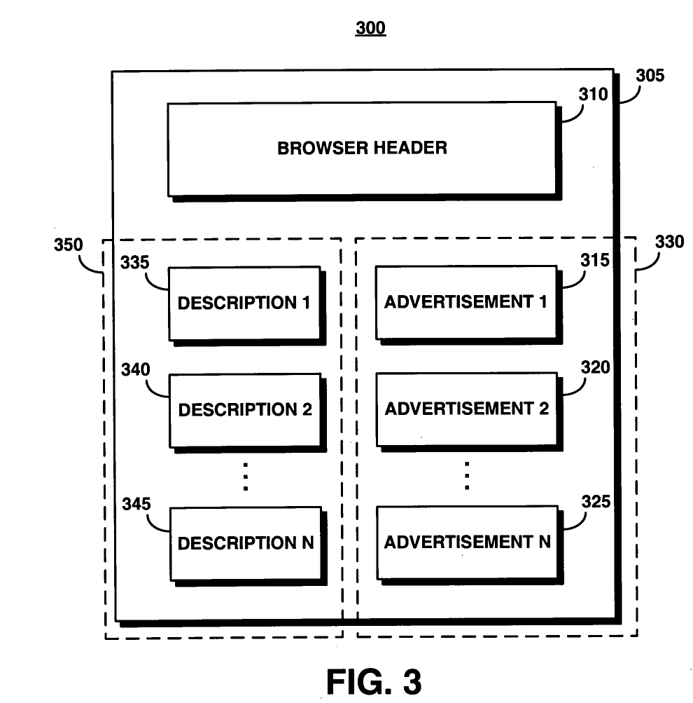

FIG. 3 illustrates an exemplary master instant ad window 300 created by system 10. Unsolicited instant ads that have been captured and saved are presented in a secondary browser window 305 with a standard browser header 310. Listed in the secondary browser window 305 are the unsolicited instant ads in their original format with all graphics, text, hypertext links, etc. In an embodiment, the unsolicited instant ads may appear in digest form, with no graphics. Exemplary unsolicited instant ads are illustrated in FIG. 3 as advertisement 1, 315, advertisement 2, 320, through advertisement N, 325, collectively referenced as advertisements 330.

Each advertisement 330 is accompanied by a description such as description 1, 335, description 2, 340, through description N, 345, collectively referenced as descriptions 350. Descriptions 350 may comprise the name of the retailer in advertisement 330, the date or time advertisement 330 was captured, the priority of the advertisement 330 based on user criteria, the category of the advertisement 330, etc. Information presented in descriptions 350 may be generated by system 10 or obtained from the advertisement 330.

It is to be understood that the specific embodiments of the invention that have been described are merely illustrative of certain applications of the principle of the present invention. Numerous modifications may be made to a system and method for managing the display of unsolicited instant Web advertisements described herein without departing from the spirit and scope of the present invention. Moreover, while the present invention is described for illustration purpose only in relation to the WWW, it should be clear that the invention is applicable as well, for example, to an intranet, a wide area network, or any other network in which devices may be interconnected for communications purposes.

1. A method of managing a display of an unsolicited instant advertisement, comprising:
detecting an attempt to display the unsolicited instant advertisement in a primary browser window; and
relocating the unsolicited instant advertisement to an alternate location that is not part of the primary browser window, without deleting the unsolicited instant advertisement.

2. The method of claim 1, wherein the alternate location comprises a secondary browser window.

3. The method of claim 1, wherein the alternate location comprises a container.

4. The method of claim 1, wherein the alternate location comprises any one of a file or a database.

5. The method of claim 1, further comprising automatically displaying the unsolicited instant advertisement in the primary browser window if the unsolicited instant advertisement meets a user-defined authorization criterion.

6. The method of claim 1, further comprising filtering the unsolicited instant advertisement by a user-defined filtering criterion.

7. The method of claim 6, further comprising filtering the unsolicited instant advertisement by a plurality of user-defined filtering criteria; and
further automatically displaying the unsolicited instant advertisement in the primary browser window if the unsolicited instant advertisement meets at least some of the plurality of user-defined filtering criteria.

8. The method of claim 6, further comprising deleting the unsolicited instant advertisement that fails the filtering criterion.

9. The method of claim 8, further comprising saving the unsolicited advertisement that meets the filtering criterion.

10. The method of claim 9, further comprising notifying a user that the unsolicited instant advertisement has been saved.

11. The method of claim 10, wherein notifying the user comprises presenting a visual indicator in the primary web browser.

12. The method of claim 10, wherein notifying the user comprises presenting an audible indicator.

13. The method of claim 10, further comprising prioritizing and categorizing the unsolicited instant advertisement that has been saved.

14. The method of claim 13, further comprising aggregating unsolicited instant advertisements in the alternate location.

15. The method of claim 14, wherein the unsolicited instant advertisements are stored with corresponding descriptions.

16. The method of claim 1, further comprising recording an attempt to display an unsolicited instant advertisement is recorded in a log.

17. The method of claim 16, further comprising transmitting the log to the user.

18. The method of claim 1, further comprising saving the unsolicited instant advertisement in an original form with corresponding text, graphics, and hypertext links.

19. The method of claim 1, further comprising saving the unsolicited instant advertisement in a digest form without graphics.

20. The method of claim 1, wherein the unsolicited instant advertisement comprises any of a pop-up advertisement or a pop-under advertisement.

21. A computer program product having instruction codes for managing a display of an unsolicited instant advertisement, comprising:
a first set of instruction codes for detecting an attempt to display the unsolicited instant advertisement in a primary browser window; and
a second set of instruction codes for relocating the unsolicited instant advertisement to an alternate location that is not part of the primary browser window, without deleting the unsolicited instant advertisement.

22. The computer program product of claim 21, wherein the alternate location comprises a secondary browser window.

23. The computer program product of claim 21, wherein the alternate location comprises a container.

24. The computer program product of claim 21, wherein the alternate location comprises any one of a file or a database.

25. The computer program product of claim 21, further comprising a third set of instruction codes for automatically displaying the unsolicited instant advertisement in the primary browser window if the unsolicited instant advertisement meets a user-defined authorization criterion.

26. The computer program product of claim 21, further comprising a fourth set of instruction codes for filtering the unsolicited instant advertisement by a user-defined filtering criterion.

27. The computer program product of claim 26, further comprising a fifth set of instruction codes for filtering the unsolicited instant advertisement by a plurality of user-defined filtering criteria; and
a sixth set of instruction codes for automatically displaying the unsolicited instant advertisement in the primary browser window if the unsolicited instant advertisement meets at least some of the plurality of user-defined filtering criteria.

28. The computer program product of claim 26, further comprising a seventh set of instruction codes for deleting the unsolicited instant advertisement that fails the filtering criterion.

29. The computer program product of claim 28, further comprising an eight set of instruction codes for saving the unsolicited advertisement that meets the filtering criterion.

30. The computer program product of claim 29, further comprising a ninth set of instruction codes for notifying a user that the unsolicited instant advertisement has been saved.

31. A system for managing a display of an unsolicited instant advertisement, comprising:
a detection engine that detects an attempt to display the unsolicited instant advertisement in a primary browser window; and
a relocation module for relocating the unsolicited instant advertisement to an alternate location that is not part of the primary browser window, without deleting the unsolicited instant advertisement.

32. The system of claim 31, wherein the alternate location comprises a secondary browser window.

33. The system of claim 31, wherein the alternate location comprises a container.

34. The system of claim 31, wherein the alternate location comprises any one of a file or a database.

35. The system of claim 31, further comprising a filter that determines if the unsolicited instant advertisement meets a user-defined authorization criterion and that automatically displays the unsolicited instant advertisement in the primary browser window if the unsolicited instant advertisement meets a user-defined authorization criterion.

36. The system of claim 35, wherein the filter filters the unsolicited instant advertisement by a plurality of user-defined filtering criteria, and automatically displays the unsolicited instant advertisement in the primary browser window if the unsolicited instant advertisement meets at least some of the plurality of user-defined filtering criteria.

37. The system of claim 36, wherein the filter deletes the unsolicited instant advertisement that fails the filtering criterion.

38. The system of claim 37, wherein the filter saves the unsolicited advertisement that meets the filtering criterion.

39. The system of claim 38, further comprising a notification module that notifies a user that the unsolicited instant advertisement has been saved.

40. The system of claim 31, wherein the unsolicited instant advertisement comprises any of a pop-up advertisement or a pop-under advertisement.
